(19) United States
(12) Patent Application Publication
(10) Pub. No.: US 2008/0133655 A1
(43) Pub. Date: Jun. 5, 2008

(54) Network system

(76) Inventors: Kazuhiro Watada, Tokyo (JP); Kota Yasunaga, Tokyo (JP); Yusaku Miyazaki, Kanagawa (JP)

Correspondence Address: MCDERMOTT WILL & EMERY LLP, 600 13TH STREET, NW, WASHINGTON, DC, 20005-3096, US

(21) Appl. No.: 11/976,494

(22) Filed: Oct. 25, 2007

(30) Foreign Application Priority Data
Nov. 30, 2006 (JP) 2006-323798

(51) Int. Cl. G06F 15/16

(52) U.S. Cl. 709/203

(57) ABSTRACT

A mobile communication apparatus are provided with a CPU 303 for processing data of contents, a flush memory 308 for storing program information relating to information of a program with which the CPU 303 can execute content data, and an RF portion 307 which transmits a request for content data and the program information to an external sever which provides the content processing information having content data and an executable program and receives the content processing information from the external server. The CPU 303 processes the content data based on the executable program.

### BACKGROUND OF THE INVENTION

1. Field of the Invention

The present invention relates to a content server, a data conversion server, a network system, a data processing method, a content providing method and a data conversion method.

2. Description of the Related Art

Conventionally, in the case of reproducing, at a mobile terminal, a still image, a moving image, a music, a game etc. downloaded from a network, it was necessary to perform decoding processing on the mobile terminal. Since there are various kinds of file formats for contents, a high-performance and large-scaled hardware resource is required in order to cope with all the formats on the mobile terminal, which results in the increase of the cost thereof.

Hereinafter, the configuration thereof will be explained below. As shown in FIG. 11, in the case of downloading content data stored in a content data storing portion 1113 from a client terminal 1112, the client terminal transmits a content transmission request to a contents provider, then downloads the content data via the internet network and temporarily stores in the inner memory of the client terminal 1112. The general inner configuration of the client terminal 1112 for performing the reproduction is shown in FIG. 12.

The client terminal 1112 includes a DSP (Digital Signal Processor) 1214 for mainly performing the codec processing, accelerator codec's 1212, 1213 each for performing the hardware acceleration as to the software processing which is insufficient in the processing ability of the DSP processing, a CPU 1217 for performing various kinds of processings, a user interface portion 1216 such as a key board, buttons switches, a drawing processing hardware 1215 for performing a drawing processing of an LCD, a radio-communication base-band processing hardware 1218 for performing a processing relating to radio communication performed by an RF (radio communication portion) 1219, the RF portion 1219 for performing the radio communication, a flush memory 1220 for storing a boot program etc., and a RAM 1221 for storing images, programs etc.

After storing content data stored in the content data storing portion 1113 in the RAM 1221, the DSP 1214 activates the accelerator codec's 1212, 1213 in accordance with the codec format of the contents 1113 to perform the decoding processing, whereby the contents data can be viewed and listened. In this case, the client terminal 1112 can not utilize the format not coping with the accelerator codec's 1212, 1213.

Thus, there is disclosed a content viewing and listening system and a method thereof which has a content server storing contents, a trans code server for performing file conversion, and a client terminal (see patent document 1, for example). In this content viewing and listening system, various kinds of contents on a network can be enjoyed even in a case where the client terminal mounts only a predetermined decoder thereon or the kinds of decoders mounted on the client terminal is small.

Patent Document 1: JP-A-2004-102339

However, in the case of reproducing, at a mobile terminal, a still image, a moving image, a music, a game etc. downloaded from a network, there is a circumstance that since there are various kinds of the file formats for contents, the client terminal does not cope with the there formats and so contents of such formats can not be listened or viewed. Further, in order to cope with may file formats on a network and to reproduce, view and listen high-quality download files, many hardware resources and a processing performance are required for the client terminal, which results in the increase of cost thereof.

### SUMMARY OF THE INVENTION

The invention is made in view of such circumstances, and an object of the invention is to provide a mobile communication apparatus, a content server, a data conversion server, a network system, a data conversion method, a content providing method and a data conversion method which can execute contents with a small amount of hardware resources and a low cost even in the case of not coping with the execution format of the contents.

In order to attain the aforesaid object, the first mobile communication apparatus according to the invention is configured to include a content processing portion which processes data of contents; a program information storing portion which stores program information relating to information of a program with which the content processing portion can execute the content data; a transmission portion which transmits a request for the content data and the program information to an external sever which provides the content processing information having content data and an executable program; and a receiving portion which receives the content processing information from the external server, wherein the content processing portion processes the content data based on the executable program.

According to this configuration, it is possible to execute contents with a small amount of hardware resources and a low cost even in the case of not coping with the execution format of the contents and to view/listen and reproduce various file formats with optimum quality and at a low system cost. Further, a client terminal such as the mobile communication apparatus is not required to mount an accelerator coping with various kinds of formats and so the cost thereof can be reduced.

The second mobile communication apparatus according to the invention is configured to further include a signal input portion which inputs an input signal including at least one of a sound signal, an image signal and a character signal; and a signal processing portion which subjects the input signal to a signal processing, wherein the transmission portion transmits processed data subject to the signal processing by the signal processing portion to the external server as the content data.

According to this configuration, it is possible fort the external server to hold data inputted from own terminal and so the cost of the terminal can be reduced.

The third mobile communication apparatus according to the invention is configured in a manner that the transmission portion issues a transfer request of the processed data to the external server, the receiving portion receives the content processing information including the processed data, and the content processing portion processes the processed data based on the executable program and outputs a processing result in a predetermined output format.

According to this configuration, since data held in the external server is read in response to the transfer request and the own terminal can perform the output processing, the cost of the terminal can be reduced.

The first content server according to the invention is the content server for providing content information necessary for data processing of contents which is configured to include a content information storing portion which stores the content information including the content data, program conversion information for converting into a program capable of executing the content data and a content execution program for executing the contents; a content request receiving portion which receives content request information including a request for the contents and program information relating to information of the executable program; a program determining portion which determines whether or not the executable program coincides with the content execution program; and a content information transmission portion which transmits the content information when the executable program does not coincide with the content execution program as a result of the determination of the determining portion.

According to this configuration, even when the terminal for executing contents does not cope with the execution format of the contents, the terminal can provide program conversion information for preparing a program necessary for executing the contents.

The first data conversion server according to the invention is the data conversion server for converting a program necessary for data processing of contents which is configured to include a content information receiving portion which receives content information including the content data, program conversion information for converting into a program capable of executing the content data and a content execution program for executing the contents; a data conversion processing portion which converting the content execution program into the executable program based on the program conversion information; and a transmission portion which transmits content processing information including the content data and the executable program.

According to this configuration, even when the terminal for executing contents does not cope with the execution format of the contents, the terminal can provide program conversion information for preparing a program necessary for executing the contents. Further, it is possible to transmit the data conversion program adapted to the terminal.

The first network system according to the invention is the network system including a client terminal for performing data processing of contents, a content server for providing content information necessary for the data processing of the contents and a data conversion server for converting a program necessary for data processing of the contents, wherein the client terminal includes: a content processing portion which processes data of the contents; a program information storing portion which stores program information relating to information of a program with which the content processing portion can execute the content data; and a content request information transmission portion which transmits a request for the content data and the program information to the content server, the content server includes: a content information storing portion which stores the content information including the content data, program conversion information for converting into the executable program and a content execution program for executing the contents; a program determining portion which determines whether or not the executable program coincides with the content execution program; and a content information transmission portion which transmits the content information to the data conversion server when the executable program does not coincide with the content execution program as a result of the determination of the determining portion, and the data conversion server includes: a data conversion processing portion which converting the content execution program into the executable program based on the program conversion information; and a transmission portion which transmits the content data and the executable program to the client terminal, wherein the content processing portion of the client terminal processes the content data based on the executable program.

According to this configuration, it is possible to execute contents with a small amount of hardware resources and a low cost even in the case of not coping with the execution format of the contents and to view/listen and reproduce various file formats with optimum quality and at a low system cost. Further, a client terminal such as the mobile communication apparatus is not required to mount an accelerator coping with various kinds of formats and so the cost thereof can be reduced. Further, since the program for executing the contents can be received, it is not required to mount a program for executing a content file.

The second network system according to the invention is configured in a manner that a plurality of the client terminals are provided, a plurality of the data conversion servers are provided, the client terminal communicates with one of the data conversion servers which locates nearest to the client terminal, and communication is made between the data conversion servers by using compression data as the data.

According to this configuration, for example, a high-speed communication network is utilized only between the client terminal and the data transfer server, and compressed data is used for the communication of a long distance such as the communication between the data transfer servers, so that the entire cost of the system can be reduced since a relatively low speed or existing communication network is utilized. Further, the client terminal is not required to mount an accelerator coping with various kinds of formats and so the cost of the client terminal can be reduced.

The first data processing method according to the invention is the data processing method in which a mobile communication apparatus performs data processing of contents, steps performed by the mobile communication apparatus including: a content processing step of performing data processing of contents; a transmitting step of transmitting a request for the content data and program information relating to information of a program used in the data processing of the contents and being capable of executing the content data, to an external sever which provides the content processing information having the content data and the executable program; and a step of receiving the content processing information from the external server, wherein in the content processing step, the content data is processed based on the executable program.

According to this method, it is possible to execute contents with a small amount of hardware resources and a low cost even in the case of not coping with the execution format of the contents and to view/listen and reproduce various file formats with optimum quality and at a low system cost. Further, a client terminal such as the mobile communication apparatus is not required to mount an accelerator coping with various kinds of formats and so the cost thereof can be reduced.

The first data processing method according to the invention is the content providing method for providing content information necessary for a content server to perform data processing of contents, steps performed by the content server including: a step of holding the content information including the content data, program conversion information for converting into a program capable of executing the content data and a content execution program for executing the contents; a step of receiving content request information including a request for the contents and program information relating to information of the executable program; a step of determining whether or not the executable program coincides with the content execution program; and a step of transmitting the content information when the executable program does not coincide with the content execution program as a result of the determination of the determining step.

According to this method, even when the terminal for executing contents does not cope with the execution format of the contents, the terminal can provide program conversion information for preparing a program necessary for executing the contents.

The first data conversion method according to the invention is the data conversion method of converting a program necessary for a data conversion server to perform a data processing of contents, including: a step of receiving content information including the content data, program conversion information for converting into a program capable of executing the content data and a content execution program for executing the contents; a step of converting the content execution program into the executable program based on the program conversion information; and a step of transmitting the content data and content processing information including the executable program.

According to this method, even when the terminal for executing contents does not cope with the execution format of the contents, the terminal can provide program conversion information for preparing a program necessary for executing the contents. Further, it is possible to transmit the data conversion program adapted to the terminal.

According to this method, it is possible to execute contents with a small amount of hardware resources and a low cost even in the case of not coping with the execution format of the contents.

### BRIEF DESCRIPTION OF THE DRAWINGS

FIG. 1 is a schematic diagram showing the configuration of a network system according to the first embodiment of the invention.

FIG. 2 is a detailed diagram showing the configuration of the network system according to the first embodiment of the invention.

FIG. 3 is a diagram showing the data flow in the network system according to the first embodiment of the invention.

FIG. 4 is a diagram showing the data flow in the network system according to the first embodiment of the invention.

FIG. 5 is a diagram showing the configuration of a network system according to the second embodiment of the invention.

FIG. 6 is a diagram showing the configuration of the mobile terminal of the network system according to the second embodiment of the invention.

FIG. 7 is a diagram showing the configuration of the server of the network system according to the second embodiment of the invention.

FIG. 8 is a diagram showing the configuration of a network system according to the third embodiment of the invention.

FIG. 9 is a diagram showing the configuration of the client terminal of the network system according to the third embodiment of the invention.

FIG. 10 is a diagram showing the configuration of the file conversion transfer server of the network system according to the third embodiment of the invention.

FIG. 11 is a schematic diagram showing the configuration of a network system of a related art.

FIG. 12 is a diagram showing the configuration of the client terminal of the network system of the related art.

### DESCRIPTION OF THE PREFERRED EMBODIMENTS

Hereinafter, embodiments of the invention will be explained in detail with reference to drawings.

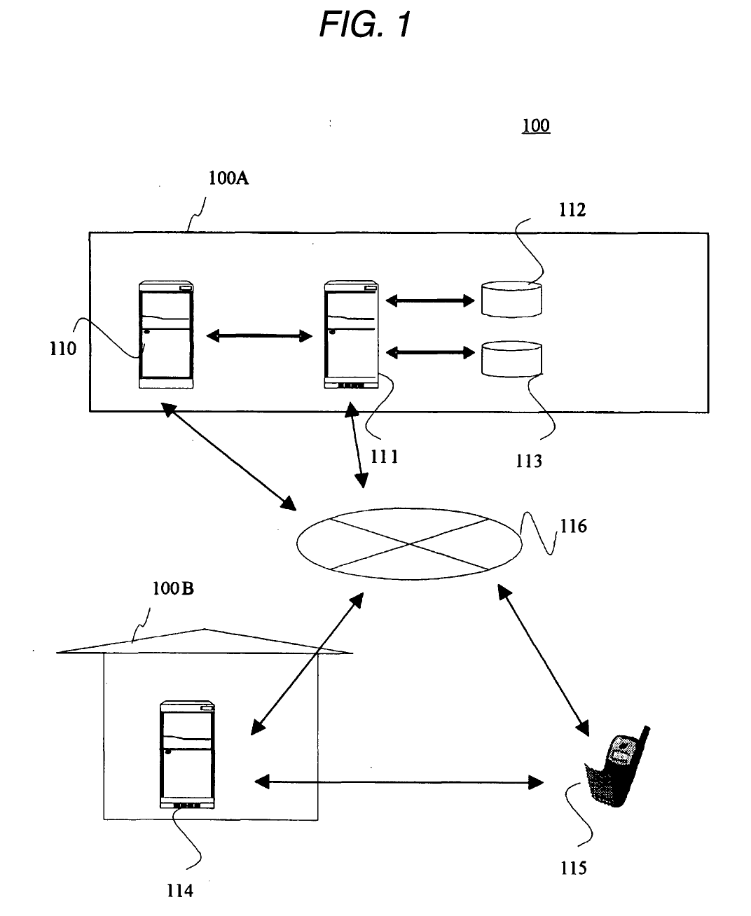

FIG. 1 is a diagram showing the configuration of a network system 100 according to the embodiment of the invention. The network system 100 according to the embodiment of the invention is configured in a manner that a content provider 100A which is configured by a conversion transfer server 110 for converting and transferring a file, a content server 111 for accumulating and providing contents and content storing portions 112 to 113 for storing content data such as image sound data and program, a home network 100B which is configured by a conversion transfer server 114 for converting and transferring a file, and a client terminal 115 for utilizing contents are coupled to a network 116 such as the internet.

When the content server 111 receives a download request from the client terminal 115, the content server transfers contents from the content storing portions 112, 113 to the conversion transfer server 110 in order to convert the format of the requested contents into a format which can be utilized at the client terminal 115. After the conversion transfer server 110 converts the format, the contents is downloaded by the client terminal 115.

In the case of uploading data to the content server 111 in order to accumulate motion pictures and sound Recorded at the client terminal 115, the client terminal 115 transmits data to the conversion transfer server 110. Then, after the conversion transfer server 110 converts the file format of the data, the content server 111 stores the converted data. In this case, when a file size of the upload data is quite large, the conversion transfer server 114 may upload via the network 116 after the conversion transfer server 114 within the home network 100B converts the file format.

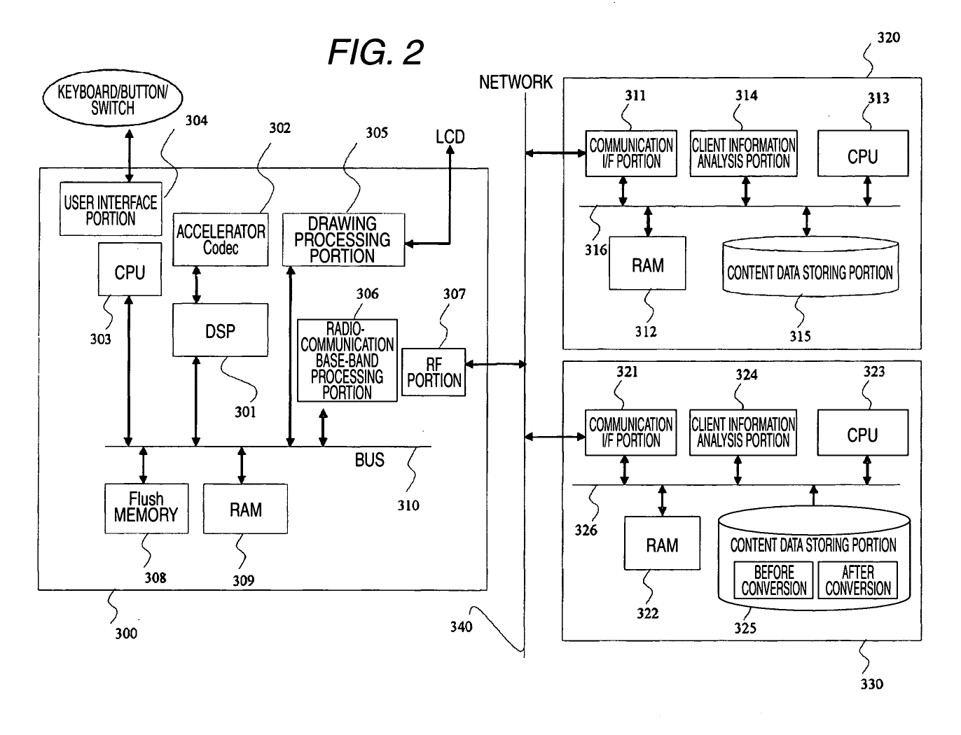

FIG. 2 shows an example of the block configuration of the network system 100 of FIG. 1. The network system 100 according to the embodiment of the invention is configured in a manner that a client terminal 300, a content server 320 and a conversion transfer server 330 are coupled via a network 340. The client terminal 300 is an example the terminal 150, the sever 320 is an example of the content server 111 and the conversion transfer server 330 is an example of the conversion transfer server 110 and the conversion transfer server 114.

The client terminal 300 includes a DSP 301 for mainly performing the codec processing, an accelerator codec 302 for performing the hardware acceleration as to the software processing which is insufficient in the processing ability of the DSP processing, a CPU 303 for performing the entire control, a user interface portion 304 such as a key board, buttons, switches, a drawing processing hardware 305 which is configured by a hardware etc. and performs a drawing processing of an LCD, a radio-communication base-band processing portion 306 which is configured by a hardware etc. and performs a processing relating to radio communication performed by an RF (radio communication portion) 307, the RF portion 307 for performing the radio communication in order to connect to the network 340, a flush memory 308 for storing a boot program and the information of the client terminal 300 etc., a RAM 309 for storing images, programs etc. and a bus 310 for connecting the respective portions shown by the symbols 301 to 309. In this embodiment, the accelerator 302 may not be mounted when the DSP 301 has a quite excellent performance.

The client terminal 300 is an example of “a mobile communication device”. The flush memory 308 has a function as “a program information storing portion”. Further, the RF portion 307 has a function of “a transmission portion” and “a receiving portion”. Further, the CPU 303 has a function of “a content processing portion”.

The content server 320 is configured to include a communication interface (I/F) portion 311 for controlling the connection with the network 340, a RAM 312 for storing client information etc., a CPU 313 for performing various controls, a client information analysis portion 314 for analyzing the client information, a content storing portion 315 for storing content data such as images, music, programs etc., and a bus 316 for connecting the respective portions shown by the symbols 311 to 315.

The content storing portion 315 is an example of “a content information storing portion”. Further, the client information analysis portion 314 is an example of “a program determining portion”. Further, the communication I/F portion 311 has functions as “a content request receiving portion” and “a content information receiving portion”.

The conversion transfer server 330 is configured to include a communication interface (I/F) portion 321 for controlling the connection with the network 340, a RAM 322 for storing instruction information relating to an instruction from the 320, a CPU 323 for performing various processings, a file conversion portion 324 for performing the content conversion and the execution program conversion, a content data storing portion 325 which is configured by a RAM etc. and holds content data and execution programs before and after the conversion, and a bus 326 for connecting the respective portions shown by the symbols 321 to 325.

The conversion transfer server 330 is an example of “a data conversion server”. Further, the file conversion portion 324 is an example of “a data conversion processing portion”. Further, the communication I/F portion 321 has functions as “a content information receiving portion” and “a transmission portion”.

First, the explanation will be made as to a case where a user views and listens to contents stored in the content server 320 on the network 340 by using the client terminal 300. The processing differs between cases where the accelerator codec 302 is mounted and not mounted.

First, the inputting is performed when the user interface portion 304 recognizes the pushing of a key board or a button switch provided at the outside portion of the client terminal 300. The CPU 303 transmits the information of the client terminal 300 stored in the flush memory 308 (information as to which kind of codec accelerator is mounted is stored when the accelerator codec 302 is mounted, whilst information of a program capable of being executed is stored when the accelerator codec 302 is not mounted) and the content request to the content server 320 connected to the network 340 via the bus 310, the radio-communication base-band processing portion 306 and the RF portion 307.

The communication I/F portion 311 transmits the information of the client terminal 300 and the content request to the RAM 312 via the bus 316 and stores in the RAM 312. The communication I/F portion 311 notifies the CPU 313 of the content request.

When the accelerator codec 302 is mounted, the CPU 313 activates the portion 14. Then, the client information analysis portion 314 accesses the RAM 312 to obtain the codec format information coping with the client terminal 300 from the client information, and further accesses the content storing portion 315 based on the requested content information to compare the codec format of the requested content with the codec format information of the client terminal 300.

When it is determined that the codec format differs as a result of the comparison, the communication I/F portion 311 transmits the codec format conversion information and the requested contents to the conversion transfer server 330 via the network 340. When the comparison result shows that the codec format is same as the codec format information, non-conversion information is transmitted as the codec format conversion information.

When the accelerator codec 302 is not mounted, the CPU 313 activates the client information analysis portion 314. Then, the client information analysis portion 314 accesses the RAM 312 to obtain the program format capable of being executed in the client terminal 300 from the client information, and further compares the program format with the execution program format coping with the content file browsing in the content storing portion 315.

When it is determined that the execution program format differs as a result of the comparison, the communication I/F portion 311 transmits the execution program format conversion information, the execution program before the conversion and the requested contents to the conversion transfer server 330 via the network 340.

When the accelerator codec 302 is mounted, the communication I/F portion 321 sends the codec format conversion information to the RAM 322 via the bus 326 and sores in the RAM 322. Further, the content data storing portion 325 stores the requested content data. The communication I/F portion 321 notifies the CPU 323 of the request.

The CPU 323 activates the file conversion portion 324 and then the file conversion portion 324 obtains the codec format conversion information from the RAM 322. The file conversion portion 324 reads the content data before the conversion from the content data storing portion 325 in accordance with the codec format conversion information obtained from the RAM 322 to perform the codec format conversion and writes the content data thus converted into the content data storing portion 325. When the conversion of all or a part of the requested contents is completed, the communication I/F portion 321 transmits the content data after the codec format conversion to the client terminal 300 via the network 340.

When the accelerator codec 302 is not mounted, the communication I/F portion 321 transmits the execution program format conversion information to the RAM 322 via the bus 326 and stores in the RAM 322. Further, the content data storing portion 325 stores the execution program before the conversion and the requested content data. The communication I/F portion 321 notifies the CPU 3232 of the request.

The CPU 323 activates the file conversion portion 324 and then the file conversion portion 324 obtains the execution program format conversion information from the RAM 322. The file conversion portion 324 reads the execution program before the conversion from the content data storing portion 325 in accordance with the execution program format conversion information obtained from the RAM 322 to perform the execution program format conversion and writes the execution program thus converted into the content data storing portion 325. When the conversion of all or a part of the execution program is completed, the communication I/F portion 321 transmits the execution program and then the requested contents to the client terminal 300 via the network 340.

When the accelerator codec 302 is mounted, the RF portion 307 sends the content data after the codec format conversion to the RAM 309 via the radio-communication base-band processing portion 306 and the bus 310 and stores in the RAM 309. The radio-communication base-band processing portion 306 issues a processing request to the DSP 301.

The DSP 301 reads the content data from the RAM 309 to perform the decode processing by using the accelerator codec 302 and writes the content data thus processed in the RAM 309. The CPU 303 reads the content data from the RAM 309 to perform the decoding processing by using the accelerator codec 302 and writes the content data thus processed in the RAM 309. The CPU 303 outputs the decoded data to the LCD by using the drawing processing portion 305 for processing the data. When the content data is sound/music data, this data is outputted to an external speaker or headphone via a not-shown sound/music processing portion.

When the accelerator codec 302 is not mounted, the RF portion 307 sends the execution program after the conversion and the requested contents to the RAM 309 via the radio-communication base-band processing portion 306 and the bus 310 and stores in the RAM 309. The radio-communication base-band processing portion 306 issues a processing request to the DSP 301.

The DSP 301 loads the execution program from the RAM 309, then reads the content data tp perform the decoding processing in accordance with the execution program, and rites the content data thus processed in the RAM 309. The CPU 303 outputs the decoded data to the LCD by using the drawing processing portion 305. When the content data is sound/music data, this data is outputted to the external speaker or headphone via the not-shown sound/music processing portion.

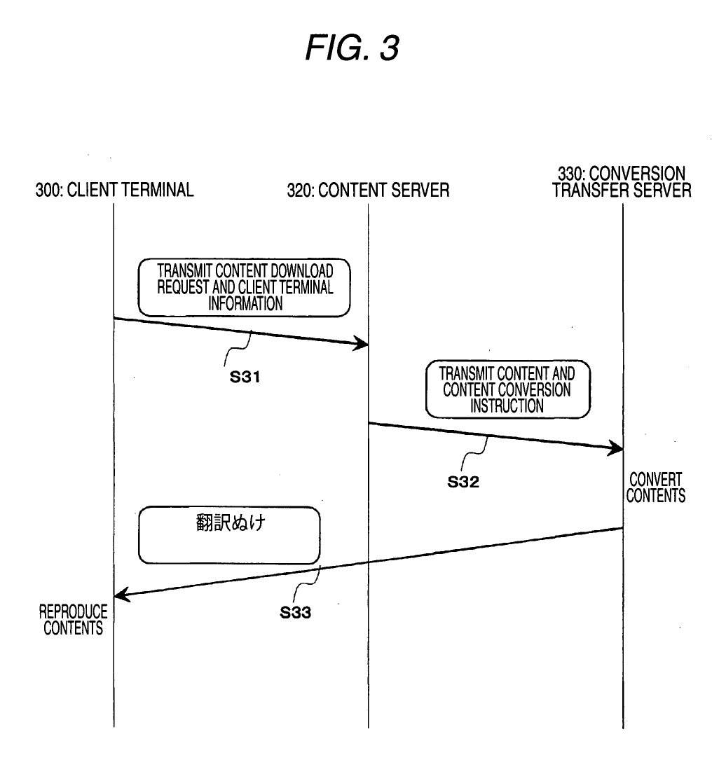

FIG. 3 is a diagram showing the data flow in the network system 100 in the case where the accelerator codec 302 is mounted in the first embodiment of the invention.

The client terminal 300 transmits the download request of the content file and the information of the client terminal 300 to the sever 320 via the network 340 (step S31).

The content server 320 determines, in accordance with the download request and the information of the client terminal 300 received from the client terminal 300, whether or not the file format of the content file to be transmitted to the client terminal 300 can be reproduced at the client terminal 300.

As a result, when it is determined that the reproduction is impossible, the contents and the conversion instruction thereof are transmitted to the conversion transfer server 330 (step S32). The conversion transfer server 330 converts the format of the received content file in accordance with the conversion instruction. After the completion of the conversion of the contents, the conversion transfer server 330 transmits the contents after the conversion to the client terminal 300 (step S33). Thus, the client terminal 300 can perform the reproduction processing of the contents.

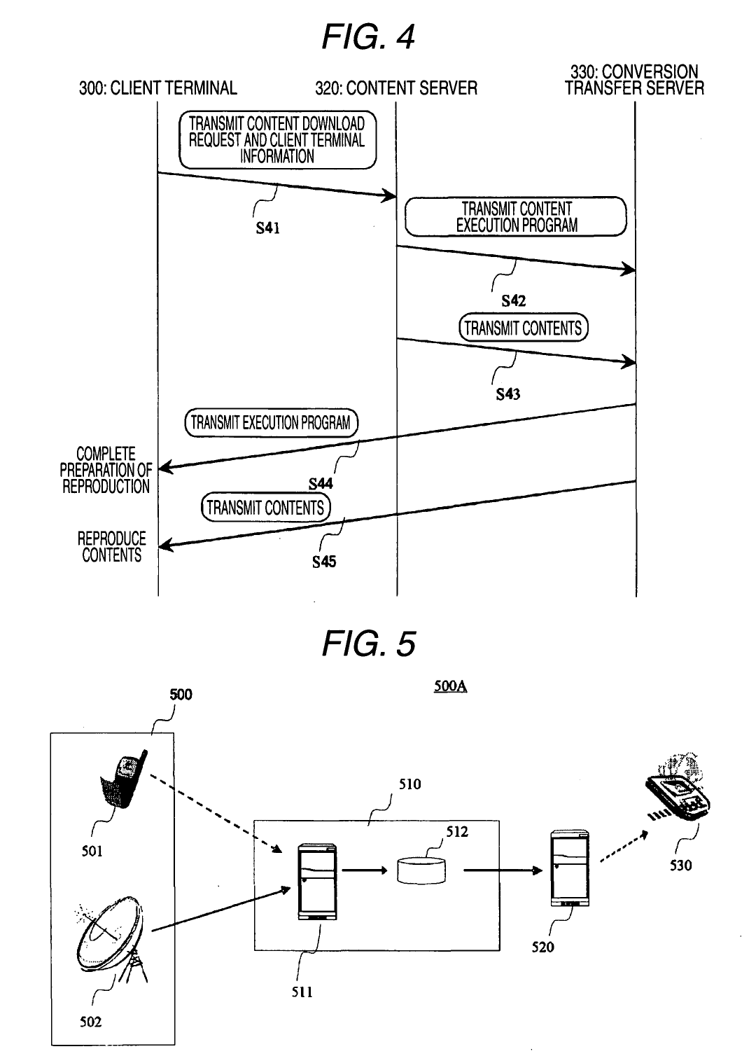

FIG. 4 is a diagram showing the data flow in the network system 100 in the case where the accelerator codec 302 is not mounted in the first embodiment of the invention.

The client terminal 300 transmits the download request of the content file and the information of the client terminal 300 to the sever 320 via the network 340 (step S41).

The content server 320 determines the content execution program to be transmitted to the client terminal 300 in accordance with the download request and the information of the client terminal 300 received from the client terminal 300, and transmits the content execution program to the conversion transfer server 330 (step S42) and further transmits the requested contents to the conversion transfer server 330 (step S434).

The conversion transfer server 330 transmits the execution program according to the instruction of the received content execution program to the client terminal 300 (step S44). Thus, the preparation for the reproduction is completed. Next, the content file is transmitted to the client terminal 300 side (step S45). Thus, the client terminal 300 can perform the reproduction processing of the contents.

Accordingly, since it becomes unnecessary to cope with the various codec formats on the client terminal 300 side, the size of the circuit can be made small thereby to miniaturize the client terminal 300 and so the cost can be reduced.

### Second Embodiment

FIG. 5 is a diagram showing the configuration of an example of a network system 500A according to the second embodiment of the invention.

The network system 500A according to the second embodiment of the invention is configured in a manner that a provider 500, a content server 510, a sever 520 and a client terminal 530 are coupled. The provider 500 represents a unit which provides various kinds of information such as a mobile phone 501 with a camera or a broadcasting service 502. The content server 510 is configured to have a network computer 511 and a recording device 512 from recording image/sound data etc.

The information provided from the provider 500 is stored in the recording device 512 via the network computer 511. The information such as image/sound data stored in the recording device 512 is not limited particularly and may be stored in accordance with the format provided from the provider 500.

In the case of browsing the information stored in the recording device 512 by the client terminal 300, the client terminal 530 notifies the file conversion server 520 of the format capable of reproducing by itself. The file conversion server 520 obtains the information from the content server 510, then converts the format of the data into format capable of being reproduced by the client terminal 530 and transmits the converted data to the client terminal 530. The client terminal 530 reproduces the transmitted data. The data transmitted to the client includes a program capable of being executed at the client terminal 530 so as to process the information obtained from the content server.

As described above, since the information held by the provider 500 is not limited and the client terminal 530 is no required to have a dedicated accelerator, the entire cost of the system can be reduced.

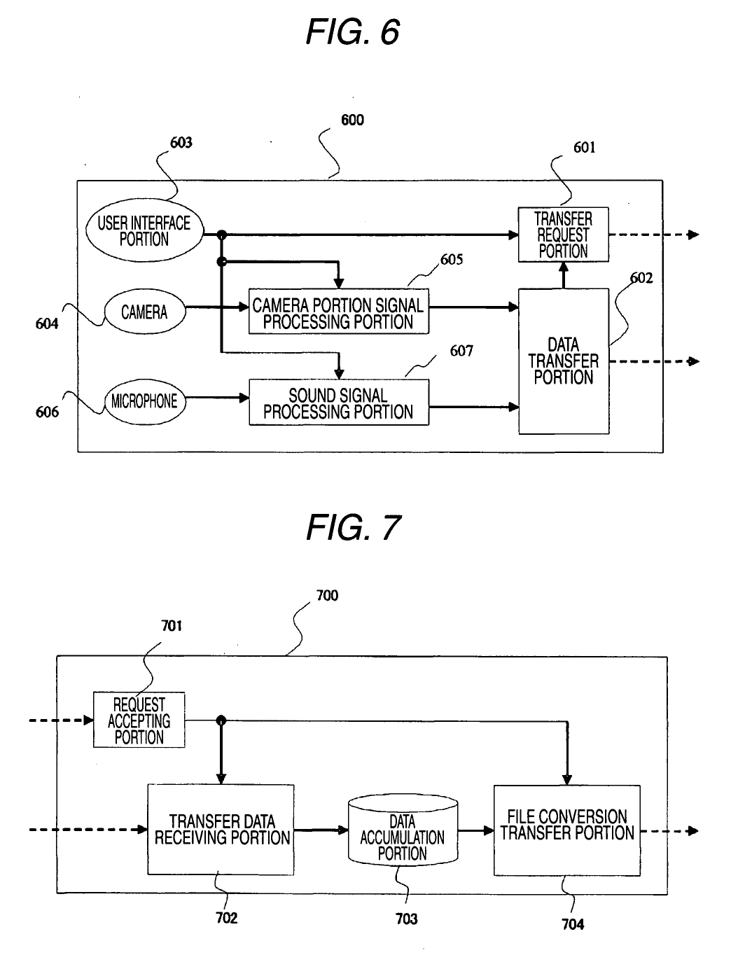

FIG. 6 is a diagram showing the configuration of an example of a mobile terminal coupled to the network system 500A shown in FIG. 5. The mobile terminal 600 is configured to include a transfer request portion 601 for requesting the data transfer, a data transfer portion 602 for performing a data transfer processing, a user interface portion 603 such as a shutter, buttons or switches, a camera 604 for picking up an image of a subject to be imaged, a camera portion signal processing portion 605 for processing the image picked-up by the camera 604, a microphone 605 for collecting sound etc., and a sound signal processing portion 607 for processing the sound etc. collected by the microphone 606. The mobile terminal 600 is an example of the client terminal 530.

Each of the camera 604 and the microphone 606 is an example of “a signal input portion”. Further, each of the portion 605 and the sound signal processing portion 607 is an example of “a signal processing portion”.

In the case of picking up a still image by the mobile terminal 600, immediately after the user interface portion 603 recognizes the depression of the shutter, the transfer request portion 601 issues a transfer request. Simultaneously, the camera portion signal processing portion 605 subjects an image picked-up by the camera 604 to a digital signal processing. The data transfer portion 602 transmits the processing result of the camera portion signal processing portion 605. The data transfer portion 602 withdraws the transfer request after the completion of the data transfer.

In the case of recording sound by the mobile terminal 600, immediately after the user interface portion 603, recognizes the depression of a recording switch, the transfer request portion 601 issues the transfer request. Simultaneously, the sound signal processing portion 607 subjects sound information collected by the microphone 606 to a digital signal processing. The data transfer portion 602 transmits the processing result of the sound signal processing portion 607. When the user interface portion 603 recognizes the depression of a stop switch, the data transfer portion 602 withdraws the transfer request of the transfer request portion 601 and the sound signal processing portion 607 also stops the processing.

Thus, the mobile terminal 600 is not necessary to have a means for storing data and so the cost thereof can be reduced.

FIG. 7 is a diagram showing the configuration of an example of a server coupled to the network system 500A shown in FIG. 5. The server 700 is configured to include a request accepting portion 701 for accepting a transfer request of data, a transfer data receiving portion 702 for receiving transfer data, a data accumulation portion 703 for accumulating data and a file conversion transfer portion 704 for performing a data conversion processing of a file and a transfer processing. The server 700 is an example of the file conversion server 520.

When the request accepting portion 701 accepts the transfer request from the mobile terminal 600, the request accepting portion immediately sends an instruction to the transfer data receiving portion 702 to place in a state capable of receiving data. The transfer data receiving portion 702 receives data transferred from the mobile terminal 600 and records the received data in the data accumulation portion 703.

When the request accepting portion 701 accepts the transfer request from the mobile terminal 600 requesting for transferring to the terminal, the request accepting portion requests the file conversion transfer portion 704 to convert data in a format requested by the mobile terminal 600. The request accepting portion 701 reads out data from the data accumulation portion 703 and perform the file conversion as to the data in accordance with the request from the request accepting portion 701. The file conversion transfer portion 704 transmits the data thus converted to the mobile terminal 600.

Thus, the network system capable of reducing the cost thereof can be realized.

### Third Embodiment

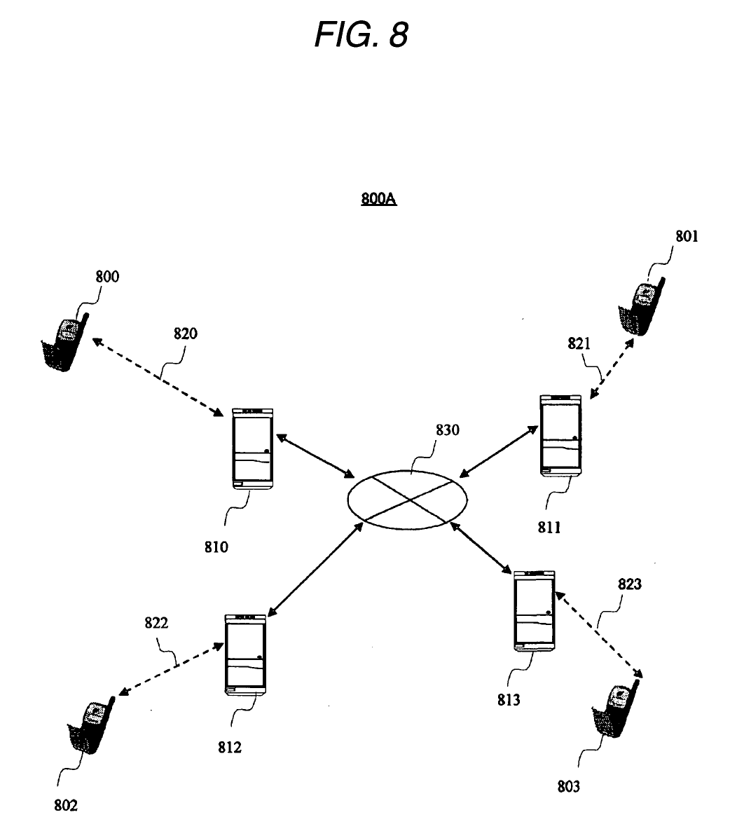

FIG. 8 is a diagram showing the configuration of an example of the network system according to the third embodiment of the invention.

The network system 800A according to the third embodiment of the invention is configured to include client terminals 800 to 803, file conversion transfer servers 810 to 813, high-speed networks (communication networks) 820 to 823 and a low-speed network (communication network) 830. The client terminals 800 to 803 represent various kinds of devices such as a video-phone.

The explanation will be made with reference to FIG. 8 as to an example where a communication is made by a video-phone between the client terminal 800 and the client terminal 801. The client terminal 800 is coupled to the file conversion transfer server 810 located near this terminal via the high-speed communication network 820. Further, the client terminal 801 is coupled to the file conversion transfer server 811 located near this terminal via the high-speed communication network 821.

The client terminal 800 transfers obtained image data and/or sound data to the file conversion transfer server 810 via the high-speed communication network 820. Also, the client terminal 801 transfers obtained image data and/or sound data to the file conversion transfer server 811 via the high-speed communication network 821.

The file conversion transfer server 810 compresses the data transferred from the client terminal 800 and transfers the compressed data to the file conversion transfer server 811 via the low-speed network 830. Also, the file conversion transfer server 811 compresses the data transferred from the client terminal 801 and transfers the compressed data to the file conversion transfer server 810 via the low-speed network 830.

The file conversion transfer server 811 expands the compressed data transferred from the file conversion transfer server 810 and transmits the expanded data to the client terminal 801 via the high-speed communication network 821. The client terminal 801 reproduces the received data. Also, the file conversion transfer server 810 expands the compressed data transferred from the file conversion transfer server 811 and transmits the expanded data to the client terminal 800 via the high-speed communication network 820. The client terminal 800 reproduces the received data.

Thus, it is possible to realize a service such as a video-phone which requires a teal-time processing.

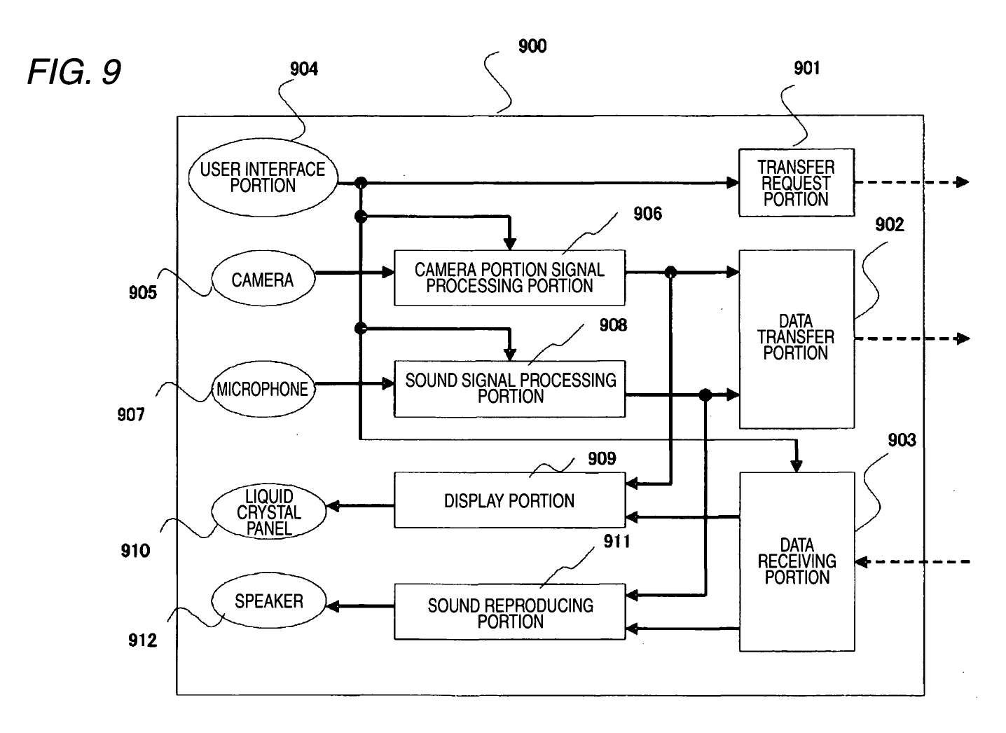

FIG. 9 is a diagram showing the configuration of an example of a terminal 900 coupled to the network system 800A shown in FIG. 8. The terminal 900 is configured to include a transfer request portion 901 for requesting the data transfer, a data transfer portion 902 for performing a data transfer processing, a data receiving portion 903 for performing a data receiving processing, a user interface portion 904 such as a calling button, a camera 905 for picking up an image of a subject to be imaged, a camera portion signal processing portion 906 for processing the image picked-up by the camera 905, a microphone 907 for collecting sound etc., a sound signal processing portion 908 for processing the sound etc. collected by the microphone 907, a display portion 909 for instructing various kinds of displays, a liquid crystal panel 910 for displaying various kinds of information in accordance with the instruction from the display portion 909, a sound reproducing portion 911 for instructing the reproduction of sound etc., and a speaker 912 for reproducing various kinds of information in accordance with the instruction from the sound reproducing portion 911. The client terminal 900 is an example of the client terminals 800 to 803 and an example of “a mobile communication terminal”.

In the case of communicating with the video-phone at the client terminal 900, immediately after the user interface portion 904 recognizes the depression of the calling button, the transfer request portion 901 issues a transfer request. Simultaneously, the camera portion signal processing portion 906 subjects an image picked-up by the camera 905 to a digital signal processing. The data transfer portion 902 transmits the processing result of the camera portion signal processing portion 906. Also, the sound signal processing portion 908 subjects sound information collected by the microphone 907 to a digital signal processing. The data transfer portion 902 transmits the processing result of the sound signal processing portion 908.

The data receiving portion 903 starts to receive data after the user interface portion 904 recognizes the depression of the calling button. The portion 903 sends the image data of the received data to the display portion 909 and sends the sound data of the received data to the sound reproducing portion 911.

The display portion 909 processes the received image data and the processed result of the camera portion signal processing portion 906 in a format capable of being displayed thereby to display on the liquid crystal panel 910.

The sound reproducing portion 911 processes the received sound data and the processed result of the sound signal processing portion 908 in a format capable of being outputted as sound thereby to output from the speaker 912.

When the user interface portion 904 recognizes the depression of a call ending button, this interface portion withdraws the transfer request of the transfer request portion 601 and simultaneously stops the operations of the camera portion signal processing portion 906 and the portion 907.

Thus, the client terminal 900 is not necessary to have a means for storing data nor a particular accelerator for compressing and expanding moving images and so the cost thereof can be reduced.

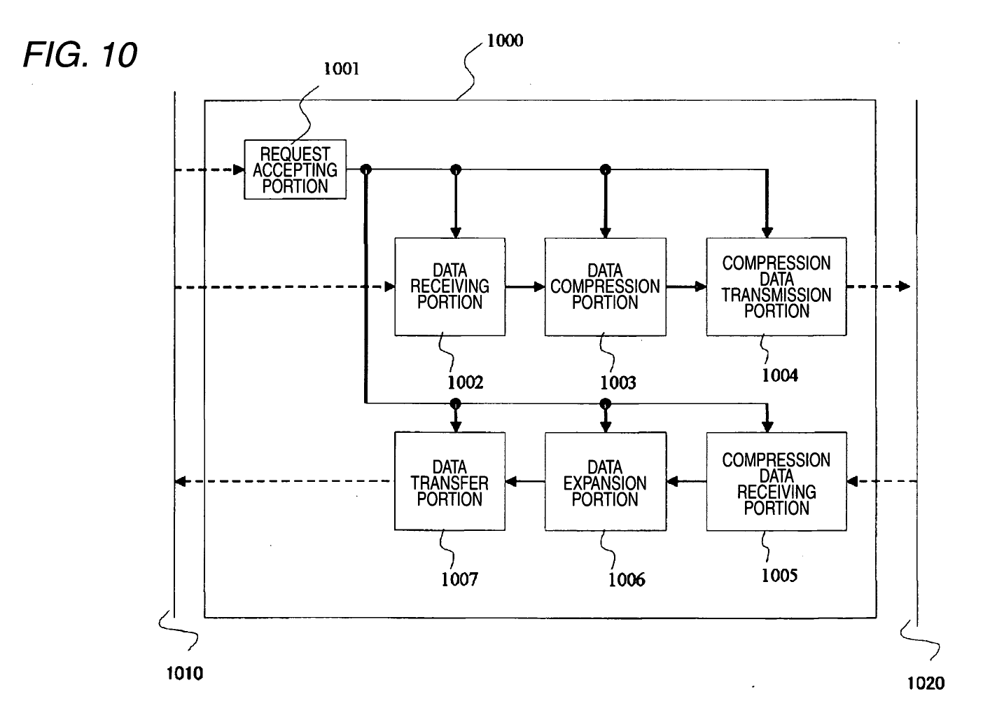

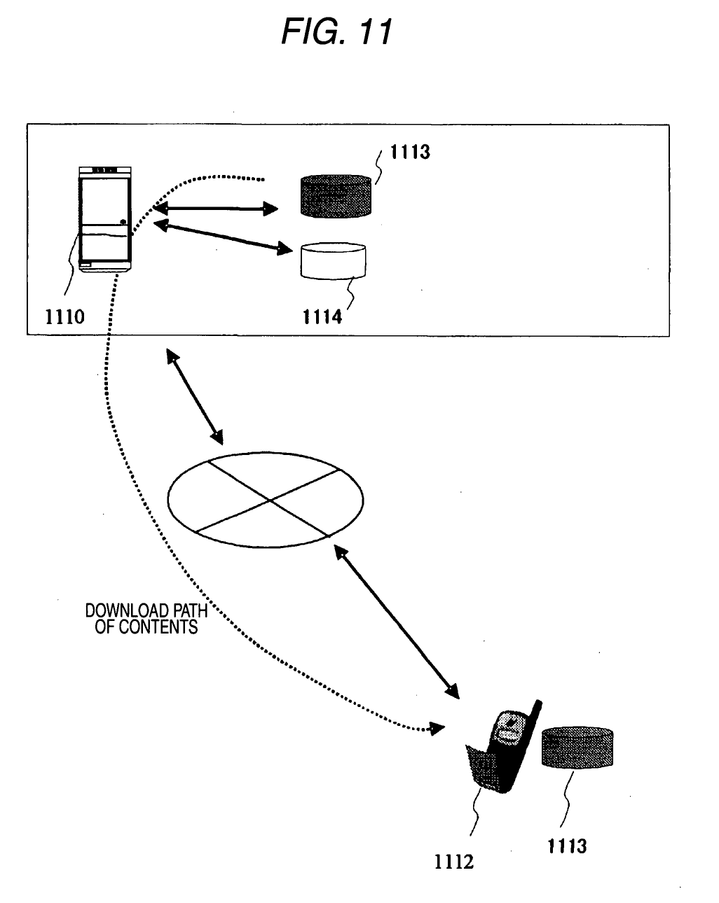

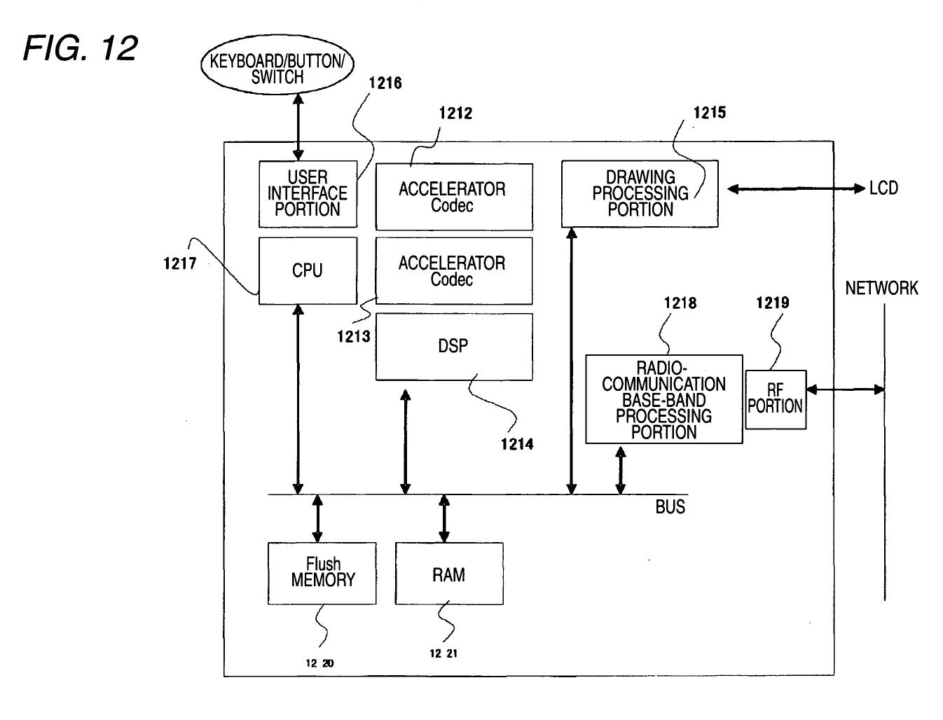

FIG. 10 is a diagram showing the configuration of an example of a file conversion transfer server coupled to the network system 800A shown in FIG. 8. The file conversion transfer server 1000 is configured to include a request accepting portion 1001 for accepting a transfer request of data, a transfer data receiving portion 1002 for receiving data, a data compression portion 1003 for compressing data, a compression data transmission portion 1004 for transferring the compressed data, a compression data receiving portion 1005 for receiving the compressed data, a data expansion portion 1006 for expanding the compressed data and a data transfer portion 1007 for transferring data. The file conversion transfer server 1000 is an example of the file conversion transfer servers 810 to 813 and an example of “a data transfer server”.

When the request accepting portion 1001 accepts the transfer request from the client terminal 900, the request accepting portion immediately sends an instruction to the respective portions to place in a state capable of receiving data. The transfer data receiving portion 1002 receives data transferred from the client terminal 900 via a high-speed communication network 1010 and transmits the received data to the data compression portion 1003. The data compression portion 1003 compresses the received data to the compression data transmission portion 1004 transmits the compressed data to a low-speed communication network 1020.

The compression data receiving portion 1005 receives compressed data transmitted from the file conversion transfer server 1000 to which the client terminal 900 as a communication destination is coupled, and sends the received compressed data to the data expansion portion 1006. The data expansion portion 1006 expands the received compressed data and sends the expanded data to the data transfer portion 1007. The data transfer portion 1007 transfer the received data to the client terminal 900 via the high-speed communication network 1010.

Thus, the network system capable of reducing the cost thereof can be realized.

The invention is useful for a mobile communication apparatus, a content server, a data conversion server, a network system etc. which can execute contents with a small amount of hardware resources and a low cost even in the case of not coping with the execution format of the contents and in particular, useful for a network system etc. using a portable small terminal such as a PDA (Personal Digital Assistants) or a mobile phone. Further, the invention is useful for a video-phone and an interactive broadcasting service

What is claimed is:

1. A mobile communication apparatus, comprising:
a content processing portion which processes data of contents;
a program information storing portion which stores program information relating to information of a program with which the content processing portion can execute the content data;
a transmission portion which transmits a request for the content data and the program information to an external sever which provides the content processing information having content data and an executable program; and
a receiving portion which receives the content processing information from the external server, wherein
the content processing portion processes the content data based on the executable program.

2. The mobile communication apparatus according to claim 1, further comprising:
a signal input portion which inputs an input signal including at least one of a sound signal, an image signal and a character signal; and
a signal processing portion which subjects the input signal to a signal processing, wherein
the transmission portion transmits processed data subject to the signal processing by the signal processing portion to the external server as the content data.

3. The mobile communication apparatus according to claim 2, wherein
the transmission portion issues a transfer request of the processed data to the external server,
the receiving portion receives the content processing information including the processed data, and
the content processing portion processes the processed data based on the executable program and outputs a processing result in a predetermined output format.

4. A content server for providing content information necessary for data processing of contents, comprising:
a content information storing portion which stores the content information including the content data, program conversion information for converting into a program capable of executing the content data and a content execution program for executing the contents;
a content request receiving portion which receives content request information including a request for the contents and program information relating to information of the executable program;
a program determining portion which determines whether or not the executable program coincides with the content execution program; and
a content information transmission portion which transmits the content information when the executable program does not coincide with the content execution program as a result of the determination of the determining portion.

5. A data conversion server for converting a program necessary for data processing of contents, comprising:
a content information receiving portion which receives content information including the content data, program conversion information for converting into a program capable of executing the content data and a content execution program for executing the contents;
a data conversion processing portion which converting the content execution program into the executable program based on the program conversion information; and
a transmission portion which transmits content processing information including the content data and the executable program.

6. A network system comprising a client terminal for performing data processing of contents, a content server for providing content information necessary for the data processing of the contents and a data conversion server for converting a program necessary for data processing of the contents, wherein
the client terminal includes
a content processing portion which processes data of the contents;
a program information storing portion which stores program information relating to information of a program with which the content processing portion can execute the content data; and
a content request information transmission portion which transmits a request for the content data and the program information to the content server,
the content server includes
a content information storing portion which stores the content information including the content data, program conversion information for converting into the executable program and a content execution program for executing the contents;
a program determining portion which determines whether or not the executable program coincides with the content execution program; and
a content information transmission portion which transmits the content information to the data conversion server when the executable program does not coincide with the content execution program as a result of the determination of the determining portion, and
the data conversion server includes
a data conversion processing portion which converting the content execution program into the executable program based on the program conversion information; and
a transmission portion which transmits the content data and the executable program to the client terminal, wherein
the content processing portion of the client terminal processes the content data based on the executable program.

7. The network system according to claim 6, wherein
a plurality of the client terminals are provided, a plurality of the data conversion servers are provided, the client terminal communicates with one of the data conversion servers which locates nearest to the client terminal, and communication is made between the data conversion servers by using compression data as the data.

8. A data processing method in which a mobile communication apparatus performs data processing of contents, steps performed by the mobile communication apparatus comprising:
a content processing step of performing data processing of contents;
a transmitting step of transmitting a request for the content data and program information relating to information of a program used in the data processing of the contents and being capable of executing the content data, to an external sever which provides the content processing information having the content data and the executable program; and
a step of receiving the content processing information from the external server, wherein
in the content processing step, the content data is processed based on the executable program.

9. A content providing method for providing content information necessary for a content server to perform data processing of contents, steps performed by the content server comprising:
a step of holding the content information including the content data, program conversion information for converting into a program capable of executing the content data and a content execution program for executing the contents;
a step of receiving content request information including a request for the contents and program information relating to information of the executable program;
a step of determining whether or not the executable program coincides with the content execution program; and
a step of transmitting the content information when the executable program does not coincide with the content execution program as a result of the determination of the determining step.

10. A data conversion method of converting a program necessary for a data conversion server to perform a data processing of contents, comprising:
a step of receiving content information including the content data, program conversion information for converting into a program capable of executing the content data and a content execution program for executing the contents;
a step of converting the content execution program into the executable program based on the program conversion information; and
a step of transmitting the content data and content processing information including the executable program.
